(19) United States
(12) Patent Application Publication
(10) Pub. No.: US 2008/0001579 A1
(43) Pub. Date: Jan. 3, 2008

(54) Gravity propelled generator

(76) Inventor: Kenneth Claypool, Storm Lake, IA (US)

Correspondence Address: Kenneth Claypool, 908 Erie St., Storm Lake, IA, 50588, US

(21) Appl. No.: 11/649,457

(22) Filed: Jan. 3, 2007

Related U.S. Application Data
(60) Provisional application No. 60/755,581, filed on Dec. 30, 2005.

(51) Int. Cl. H02K 7/00; H02K 53/00

(52) U.S. Cl. 322/3; 74/DIG. 9

(57) ABSTRACT

The Gravity Propelled Generator is a machine used as a method of renewable energy. It uses a pendulum attached to a solid lever that is connected to an axle. The axle is connected on both sides to a frame which rest on rails. The rails are connected to a frame that supports the whole structure. On the axle is a generator. As the pendulum falls from it's starting pointing, standing almost straight up, the wheels that are indirectly connected to it move backwards. This causes the pendulum to fall in a straight line toward the earth. The reason for this is that it causes the pendulum to gain more energy. The wheels stop when it reaches the end of it's track, just as the pendulum is at the bottom of its path. The pendulum rises to the opposite side, and then falls back down again in this cycle. This produces electrical current.

### BACKGROUND

1. Field of Invention

This invention relates to renewable energy generation, created from the gravitational force naturally produced from the planet.

2. Description of Prior Art

Energy production has been an obstacle for people since the dawn of civilization. Fire was the first to be used by the human race as a form of energy. Fire was used to initiate us to cooked foods, metal weapons and warmth. Unfortunately, heat is extremely difficult to convert into electricity, rendering fire unable to compete with our electricity consumption.

Hydro energy was used in regions with rivers to replace man power with the current of water. First used to power mills, hydro energy is still a large producer of electricity. Hydro energy does come at a high price though. Hydro energy damns are expensive to create, and take a terribly high tole on the environment. The fishing industry on the river and immediate body of water in which the river flows into can be severely damaged, ruining migration patterns and salt to water ratio in the water, assuming that the river runs into a salt water sea or ocean. Hydro energy has another flaw. Hydro energy can only be created in areas that have rivers with the proper depth and strong water currents. Although it doesn't emit pollution, the cost to the environment and economy is still high.

Coal energy is the cheapest and largest method of producing electricity that we have. This makes it the most desirable form of electricity production. The cons of coal, however, greatly out number the pros. Coal produces more Carbon Dioxide (CO₂) Watt/hr of energy than any other generation method, which is green house gas. Coal miners can leave an area scarred after coal mining because of irresponsible restoration methods of the soil surface. Coal miners also put themselves in jeopardy for the reason that coal dust can over time contaminate their lungs, leaving them with long term health problems that may lead to death. Coal factories launch horrendous amounts of ash into the air, and coal containing large amounts of Sulfur, may turn into Sulfur Dioxide, and later into Sulphuric Acid, a leading cause of acid rain. Also, a more relevant point in this day and age, large coal factories are a very unsightly to look at.

Oil is just as bad as coal, in the sense that oil also produces Carbon Dioxide (CO₂). Some oils also contain large amounts of sulfur, which can lead to acid rain, as explained in the paragraph above about coal. Oil can even lead to devastating oil spills and pollution. Oil reserves are also expected to run out by the middle of the century, with a preceding steep increase in oil prices, making oil insufficient for future energy production.

Wind power is in fact, powered by on wind. Although it has been the symbol of hope for clean and renewable energy, it has problems. To take advantage of wind power, you need open spaces. This is a huge problem for urban areas as well as forested or island areas. It's outputs are entirely the product of wind currents, making it unreliable. To produce large amounts of energy, you need multiple machines, and more machines means more maintenance and more space.

Solar energy is only a recent development. Solar energy is expensive to create, since it takes a lot of time to create the devices used, and use special silicons. These devices can also be damaged by heat, making it difficult for them to survive in hotter regions. These devices also need sunlight, making it useful only during the day, and even less useful for the regions who only receive a few hours of sunlight a day. They also become less useful in cloudy weather.

Nuclear Power has some well known consequences. The Chernobyl Explosion in Ukraine in 1986 is a perfect example. While nuclear power can produce large amounts of energy, nuclear power plants can also become unstable and cause a huge amount of radioactive contamination. Nuclear Power plants take a very long time to build and are expensive. These plants also produce nuclear waste, which can be very difficult to dispose of properly. The resources needed cause a nuclear reaction also take time to be manufactured to the right specifications, and if fallen into the wrong hands, these resources can be used to make weapons.

Although there are many other forms of energy production techniques, these are the most common, and make up almost the entire world energy production. Just like these forms of energy, they have just as many negative aspects to them.

Objects and Advantages

The objects and advantages of this invention are as follows:
a) to create electricity that is cheap and environmentally friendly;
b) produces clean and renewable energy;
c) comes at a low cost to build, and because of its simplicity, should only require low maintenance;
d) it is very adaptable to different regions, such as being able to change size, shape, and design.
e) the output energy is reliable. You always know how much your going to get. It can also be changed easily to create more or less.

### DRAWING FIGURES

The drawing is very simple, and lists the following:

FIG. 1A shows the wheels on the machine attached to the rails.

FIG. 1B shows the axle connected to the wheel attachments in a fashion that will allow the axle to turn freely while still being firmly connected to the wheel attachments.

FIG. 1C shows the generator. The rotor inside of the generator is connected to the axle, so as the axle turns, it will turn the rotor to generate electricity.

FIG. 1D shows the lever. The pendulum is connected to the lever, and acts as the pendulum's support to give the pendulum a certain path to follow.

FIG. 1E is the pendulum. Gravity's influence on the pendulum provides the energy for the machine.

FIG. 1F shows the rails. The rails are what the wheels move on, giving it a smooth and certain path.

FIG. 1G show the framework. The framework is what the whole machine rests, keeping it high off the ground so that the pendulum can make its cycle.

FIG. 1H is the stops. These stop the wheels when the pendulum has reached the bottom of it's path, also keeping the wheels from going of the track.

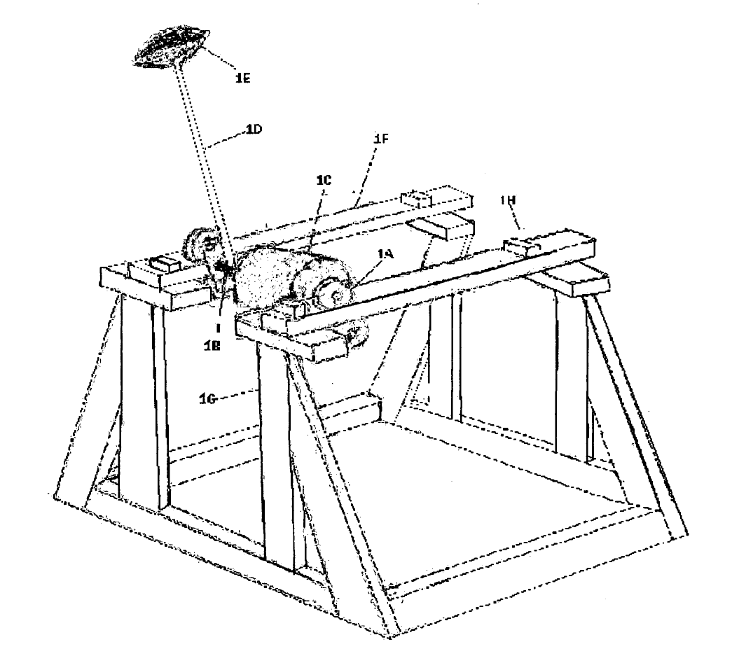

### SUMMARY

In accordance to the invention a gravity propelled object used to generate electricity by means of a generator that will convert the work of the pendulum into electrical current.

Specification/Description

The Gravity Propelled Generator can be narrowed down to the following:

A gravity propelled machine comprising of:
a) a falling body mounted on a rotating lever
b) a device used as a means to convert energy attached to said lever, whereby collecting energy from said falling object
c) a means of supporting the said lever so that the said pendulum can fulfill its purpose without interference

The Gravity Propelled Generator works on the basic theory of gravity. As the pendulum (1E) falls, it turns the generator (1C) to create electricity. As the pendulum begins to fall, the base of the lever that is attached to wheels (1A) moves backwards. The reason for this is to cause the pendulum to fall in a straight path, which causes it to fall faster, giving it more momentum. If the pendulum were to fall in a curved path, it would not gain enough energy to rise to it's original starting position. The wheels stop just when the pendulum comes to the bottom of it's path. The wheels must lock as the pendulum rises, so when it does rise, they won't go backwards prematurely. The pendulum rises to the opposite side of the structure until it reaches about 340 degrees, where it is stopped. From here, the pendulum will fall again to the opposite side of the structure and wheel base will fall backwards as before, and the cycle will continue on in this fashion. The reason it is not allowed to just keep going around without being stopped and sent in the next direction, is because the wheel base will not be able to go backwards since it has reached the end of it's track. The pendulum will not be able to fall in a straight path, which means it will gradually lose energy as it keeps cycling.

Operation

Building this machine is quite simple. First of all is the frame work (1G) that the machine will be on. In the picture, it appears to be constructed of wood. A larger scale would require better materials, such as steel. If space is a factor, you can dismiss the frame work, and opt for a design that puts the supports into the ground to keep it from moving. The framework needs to be as sturdy as possible. If the framework rocks, it will take energy away from the pendulum, causing a smaller output. The pendulum may cause the framework to lurch forward or backward, so you should take in to consideration making a longer framework, or reinforcing it into the ground. Next is the wheels (1A), axle (1B), and rails (1F). There needs to be two wheels on each side of the axle, one on top of the rail, and the other on the bottom. The bottom will prevent the machine from coming off the rails as the pendulum (1E) swings upwards, and the top will keep it from coming off as it the pendulum falls. The rails should be made of steal, though the drawing shows wood. This will prevent breakage and lower maintenance. In the drawing, it shows wooden stops (1H) that will stop the wheels at the point where the pendulum reaches the bottom of it's swing. A mechanical break would prevent the crushing lurch as the wheels hit the stops, and it would also give more control on where and and how fast it stops. The stops shown in the drawing, however, should be kept anyway, since they may act as a safety stop, if the mechanical break were to malfunction. The axle (1B) should also be strong for obvious reasons, since it will be holding the weight of all the parts. The two ends of the axle will be inside the piece that holds the wheels together, as shown in the drawing. It should be able to turn with minimum friction, while supporting the pendulum and generator. The lever (1D) that the pendulum will rest on can be made to any length desired. Again, it should be made strong. The pendulum itself should be aerodynamic, because on a large scale model air resistance may come into play. Also, you may want to consider giving the pendulum the ability to be adjustable, such as being able to move higher or lower on the lever. This will give the pendulum the possibility of being changed to a bigger or smaller one to accommodate areas where space in limited, or if it needed to be smaller in a place where materials or resources to move or maintain a larger pendulum is limited. The generator (1C) must follow strict specifications. The rotor inside the generator should be connected to the axle in such that the axle runs through the center of the rotor. The stator of the generator should be mounted onto the frame that holds the wheels together. This will keep it from moving, while the rotor inside can turn freely inside to generate electricity. Lastly is the big question. How is it that the pendulum doesn't lose a lot of moment with the generator pulling on it? In testing this, I have found that on a model with a one ounce pendulum on a four inch lever will turn up to eight ounces of weight on the axle with little energy taken away from the pendulum. Put that into a ratio, and you see the significance.

Summary, Ramifications, and Scope

Accordingly, the reader will see benefits of this machine. It can be used in any setting around the world. It's so efficient and cheap that any corporation could very easily mass produce it, and gain significant profits. For the reason that it is so cheap and efficient, this machine may also be used in third world countries, where it can give the most needed aid. It can also be used in places where raw materials are scarce and have to be imported. The machine only needs the resources to be built, nothing else is needed. The energy is clean and renewable. It's design is also more than just an engineering marvel, it's art. People will enjoy looking at it. Its size is adaptable, giving it the advantage above all other energy industries. Just by adding a larger pendulum, you can get the same out put from a smaller machine as a larger one with a pendulum proportional to its size. It's design is very simple, and easy to explain in laymen terms. If this machine ever needed to improve in the future for such things as energy demands, its simple design would make it easy for someone to look at the entire scope of it at once. This would make it easy to pinpoint where and how to improve it. Also, this market is fresh and untouched. There are no risks except competition who might move on the opportunity first. The only thing required is investing. Another advantage this machine has is its acceptability by the public. Since this is a United States patent, it's important to see how the public is starting to react to the growing environmental problem. So to capitalize on this win-win situation is vital.

Although the description above contains many specificities, these should not be construed as limiting the scope of the invention but as merely providing illustrations of some of the presently preferred embodiments of this invention. For example, there is a possibility that a large shell could be used to enclose the machine, to reduce air resistance and keep out unfavorable weather conditions that may tamper with it, such as hurricanes. Though it work almost around the clock without it, hurricanes, and tornadoes are an exception.

Thus the scope of the invention should be determined by the appended claims and their legal equivalents, rather than by the examples given.

I claim:

1. A gravity compelled machine comprising of a falling object mounted on a rotating lever this is connected to an axle, a generator used as a means to convert the energy of the pendulum attached to said axle, whereby collecting energy from said falling object, and a support system to raise said lever to a proper height.

2. The lever in claim 1 must be made be of a solid material.

3. The generator in claim 1 must have said axle running through a rotor of said generator, where as the stator must be stationary.

4. The axle in claim 1 must have two ends that are connected to the wheel frame in a state that will allow the axle to turn freely.

5. The support system in claim 1 must be high enough so that said lever will not make contact with any surface.

6. The axle in claim 1 must be connected on each side by a set of wheels, where as said wheels will be connected to rails.
